(19) United States
(12) Patent Application Publication
(10) Pub. No.: US 2006/0021481 A1
(43) Pub. Date: Feb. 2, 2006

(54) Serpentine belt tool

(75) Inventors: Thomas L. Sluzalis, Lakewood, CO (US); Michael L. Whitehead, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 10/903,782

(22) Filed: Jul. 30, 2004

(51) Int. Cl. B25B 25/00

(52) U.S. Cl. 81/486

(57) ABSTRACT

A serpentine belt tool for release of tension on a serpentine belt tensioned by a biased idler pulley mounted on a spring loaded arm includes first and second manually operable handles which may alternately be engaged with an extension bar keyed to the center spindle of the idler pulley to thereby provide ratchet like action and movement of the extension bar releasing the tension of the idler pulley on the belt.

### BACKGROUND OF THE INVENTION

In a principal aspect, the present invention relates to a tool which is utilized to control or adjust the tension of a serpentine belt, particularly a serpentine belt associated with an internal combustion engine.

Modern diesel and internal combustion engines typically include closed loop belts which have a serpentine shape inasmuch as they fit around and connect a plurality of pulleys associated with various operating components or elements of the engine. Often, a serpentine belt is tensioned by means of an idler pulley mounted at the end of a cantilever, spring loaded or spring biased arm. When seeking to repair or replace a component of an engine associated with a serpentine belt driven pulley, or when seeking to replace a serpentine belt, it is necessary to release the tension of the idler pulley on the belt.

Various tools have been developed to effect such release, including tools heretofore manufactured by Lisle Corporation and identified as Serpentine Belt Tools, Product No. 57800 and Product No. 57900. Such prior art serpentine belt tools comprise an elongate, flat bar stock handle having one or a pair of configured openings at one end designed to engage the center axle of an idler pulley. The elongate handle may then be manipulated to pivot the idler pulley and spring biased cantilever arm to release the tension on a serpentine belt thereby permitting removal of the belt. Such tools further may include handle extensions which are bolted to the elongate handle to provide further access to an idler pulley located in a hard to reach area of an engine compartment.

Nonetheless, there has remained a problem associated with the release of tension on serpentine belts. That is, for example, the amount of movement of the tension release elongate handle may be restricted in an engine compartment by virtue of the components associated with the engine or by the configuration of the engine compartment itself. Thus, there has developed the need for a serpentine belt tool which will address such issues, among others.

### SUMMARY OF THE INVENTION

Briefly the present invention comprises a serpentine belt tool for release of tension upon a serpentine belt that is tensioned by a biased idler pulley. The tool comprises first and second handles which may alternately be engaged with an extension bar that is keyed or fixed to the center spindle or shaft of the idler pulley to thereby provide ratchet-like action and incremental movement of the extension bar. Such incremental movement is transmitted to the idler pulley and the associated spring biased cantilever arm to effect release of tension on the serpentine belt. The actuation handles each include keyed openings designed to be engaged with and disengaged from keyed elements of a pivot pin projecting from the extension bar. The keyed openings of the actuation handles may be offset to enable smaller degrees of incremental movement required in highly restricted access situations.

Thus, it is an object of the invention to provide an improved serpentine belt tool which is especially useful for release of tension from an idler pulley on a belt when the pulley is located in restricted or hard to reach areas in an engine compartment.

It is a further object of the invention to provide an easily used, rugged, and economical serpentine belt tool.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of a collection of prior art serpentine belt tools;

FIG. 2 is an exploded isometric view of an embodiment of the serpentine belt tool of the invention;

FIG. 2A is an exploded plan view of the tool of FIG. 2;

FIG. 3 is a side view of the extension bar of the tool of FIG. 2;

FIG. 4 is a plan view of the extension bar of FIG. 3;

FIG. 5 is a side view of an actuation handle of the tool of FIG. 2;

FIG. 6 is a plan view of the actuation handle of FIG. 5;

FIG. 7 is a plan view of a pivot pin associated with the extension bar of the tool of the embodiment of FIG. 2;

FIG. 8 is an end view of the pin of FIG. 7;

FIG. 9 is an isometric view depicting the mode of operation of the tool of the invention;

FIG. 9A is a cross sectional view of the elements of the invention depicting the manner in which one of the handles interacts with the driving pin element;

FIG. 9B is a sectional view depicting the interaction of the second handle with the pin;

FIG. 10 is a plan view of an alternate pivotal pin for the extension bar;

FIG. 11 is a side view of a first extension handle depicting the profile of the keyed opening that co-acts with the pivot pin of FIG. 10 or FIG. 7;

FIG. 12 is a side view of a second extension handle used in combination with the handle of FIG. 11 and depicting an offset of the keyed opening that co-acts with the pivot pin;

FIG. 13 is a cross sectional view of a pivot pin of the type depicted in FIG. 10; and

FIG. 14 is a side view of the ends of a first and second extension handle designed to interact with a pin of the type depicted in FIG. 10 and FIG. 13.

### DESCRIPTION OF THE PREFERRED EMBODIMENT

FIG. 1 illustrates a collection of various prior art tools. The tools comprise elongate, flat bar-shaped handles 10 having a manual gripping end 12 and key openings 14 and 16 at the distal end 15 for engagement with the shaft head 17 of the center shaft or axial rod of an idler pulley 20. In use, one keyed opening 14 or 16 is engaged with idler pulley shaft head 17 associated with a serpentine belt of an internal combustion engine as depicted in an isometric drawing in FIG. 1 so that the handle 10 may be manually engaged to pivot the pulley 20 mounted on idler arm 19 about idler arm pivot axis or shaft 21 to release the tension on belt 18 by movement of idler pulley 20 in opposition to the biasing force on the pulley 20 derived from the biased idler arm 19. The handle 10 may have attached extensions such as an extension bar 22 so that the handle 10 and the extension bar 22 may be moved in unison to effect release of tension from an idler pulley 20 on a belt 18.

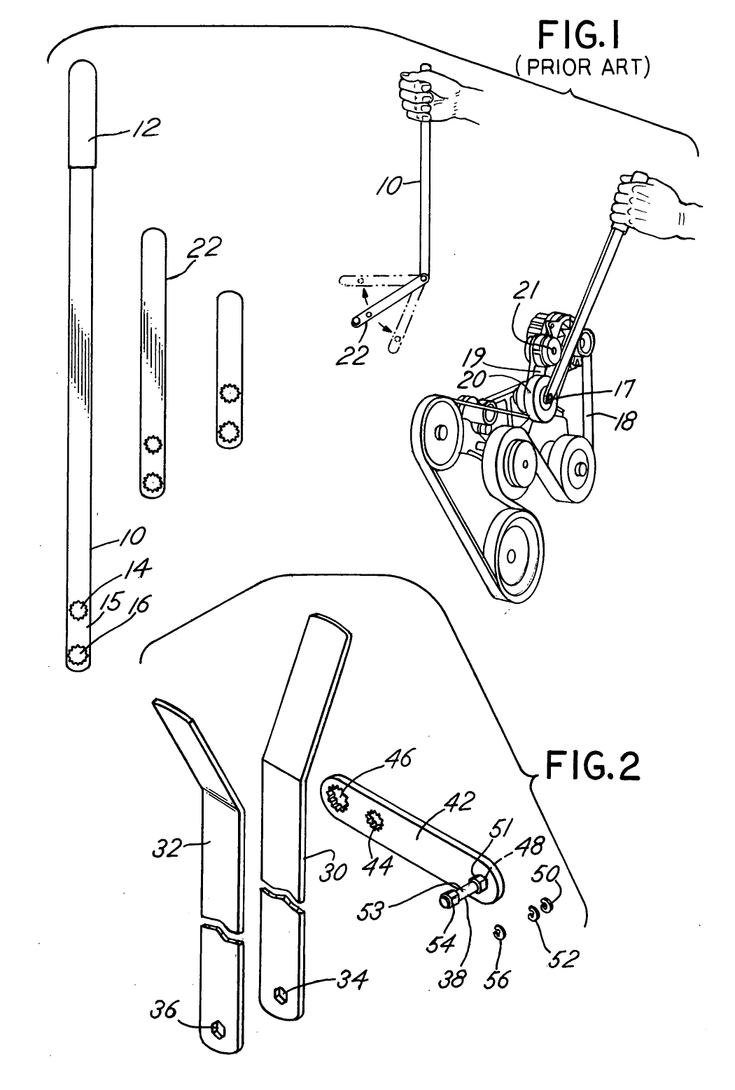

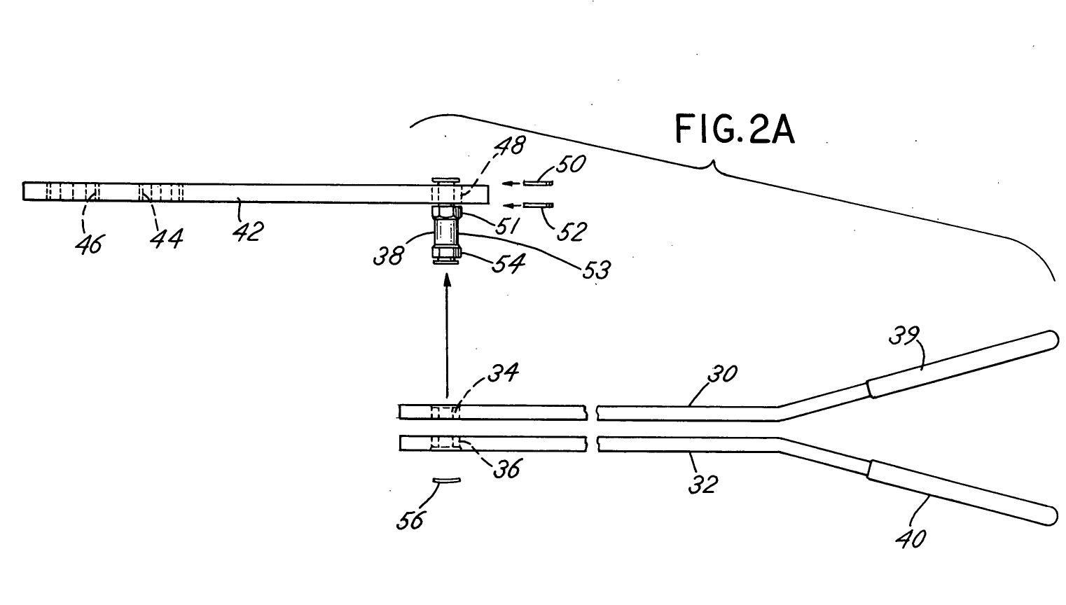

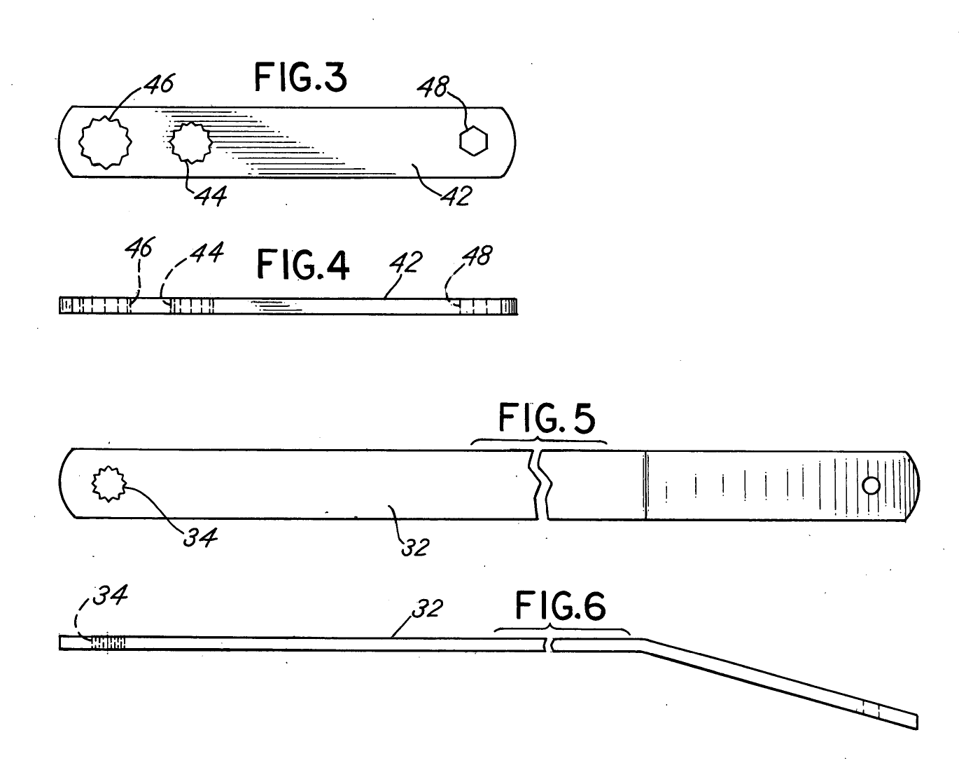

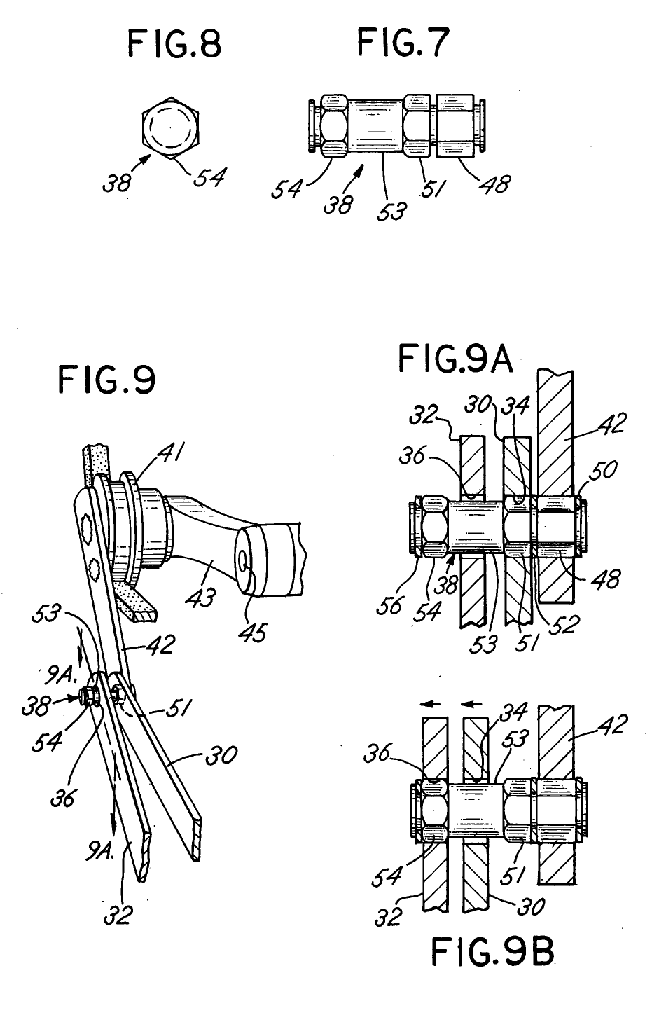

FIGS. 2 through 14 illustrate embodiments of the improved tool of the present invention. The embodiments each include a first actuation handle 30 and a second actuation handle 32. In one embodiment handles 30, 32 are substantially identical and in use are arranged in an opposed relationship as depicted, for example, in FIG. 2. Each handle 30 and 32 includes a keyed opening 34 and 36, respectively, at an inner end for receipt of a pivot pin 38. Each handle 30 and 32 also includes a grip at its outer or opposite end for manual gripping, i.e. manual grips 39 and 40, respectively. The handles 30 and 32 are made from flat bar stock and are shaped as depicted in the figures with a slight bend at about a mid-point to facilitate the manual use or gripping thereof.

An extension bar or extension arm 42 includes a first idler pulley, keyed opening or passage 44 and a second distal end idler pulley, keyed opening 46. Two openings 44, 46 are depicted and each opening 44, 46 is sized or keyed to a compatibly sized idler pulley shaft head, i.e. head 17 in FIG. 1. Thus, at least one keyed opening 44 or 46 is necessary, but two or more may be provided to accommodate pulley shaft heads of various size and configuration.

FIGS. 2-9B illustrate in further detail an embodiment of the invention. At the opposite end of the extension bar 42, pin 38 is attached and retained in an opening 48 by means of a retention clip 50 and a separate retention clip 52 on the opposite side of extension bar 42 so that pin 38 will not slide laterally. The pin 38 extends transversely from the bar stock comprising the extension bar 42. The extension bar pin 38 further includes a hexagonal, polygonal or keyed section 51 adjacent the extension bar 42 and an unkeyed center section 53 and an outer keyed section 54. The actuation handles 30 and 32 may be engaged with the pin 38 by placement through the respective keyed openings 34 and 36. A retention or retainer clip 56 retains the actuator handles 30 and 32 on the pin 38.

The first actuation handle 30 is designed to be engaged with and connected by means of keyed opening 34 to keyed section 51 of the pin 38. The second handle 32 is designed to be engaged by means of keyed opening 36 with keyed section 54 of pin 38. Each of the handles 30 and 32, however, may be positioned in the unkeyed center section 53. Thus, the unkeyed center section 53 has an axial dimension in the preferred embodiment which is slightly greater than the thickness of the two handles 30, 32 and a configuration which permits axial as well as rotational movement relative to pin 38.

In operation, one of the handles, for, example, handle 30, is engaged with the keyed section 51 so that the extension arm 42, which is affixed or keyed to the shaped end or head 17 of an idler pulley 41, may be pushed or pulled to pivot idler pulley 41 mounted on cantilever arm 43 about the fulcrum 45 or pivot axis of the arm 43. The second actuation handle 32 may then be moved from the unkeyed center section 53 and engaged with the keyed section 54 to effect further rotation of the extension bar 42 about the pivot 45. Because the openings 34 and 36 form a regular polygon, for example, a hexagon shape and further because the keyed sections 51 and 54 comprise regular polygons, for example, a hexagon, the engagement of the handles 30 and 32 with the pin 38 may be easily effected by moving the handles axially or laterally 30, 32 into and out of engagement with the unkeyed section 53 and into and out of engagement with a keyed section 51 or 54, as the case may be. The handles 30, 32 thus are manipulated out of phase or in steps with respect to each other. One handle 30 may thus move the idler pulley 41 a first distance about fulcrum 45 and be held while the second handle 32 is pivoted or rotated and then positioned on section 54 of pin 38 and manually moved to pivot the pulley 41 a further incremental distance about the axis 21 in FIG. 1. The handles 30, 32 are thus alternately engaged and disengaged and manipulated to effect release of pressure from pulley 41 on belt 18. This procedure may be used during removal and installation of belt 18.

In sum, the extension bar 42 may be manipulated to thereby engage the idler pulley 41, move the idler arm 43, and thus reduce pulley tension on the serpentine belt 18 associated with an idler pulley 41. The utilization of the two actuator arms 30 and 32 permits incremental rotational movement of the extension arm, bar or rod 42.

As previously described, FIGS. 2-9A are directed to one embodiment of the invention. FIGS. 2-9A are directed to a first embodiment of the invention wherein the keyed openings 34 and 36 associated with the handles 30 and 32, respectively, are substantially identical and thus the handles 30 and 32 are substantially identical. FIGS. 10-14 illustrate alternatives or additional embodiments wherein there is depicted a modification to the pin 38 associated with the extension arm 42 and further wherein the handles 30 and 32 are modified slightly and more particularly the keyed openings 34 and 36 are slightly rotated or out of phase with respect to one another. By making the keyed openings 34 and 36 in the embodiment of FIGS. 10-12 slightly out of phase with one another, a mechanic is enabled to pivot or rotate the idler pulley and associated cantilever arm in smaller incremental steps thus providing greater flexibility in the utility of the tool.

Referring therefore to FIGS. 10-14, it is first noted that FIG. 10 depicts in a plan view a pin 38A. The pin 38A includes a center line axis 69. The pin 38A further includes an inner keyed section 51A and an outer keyed section 54A substantially identical to the keyed sections 51 and 54 of the pin 38. A center, unkeyed section 53A, however, has a distinct or different configuration. That is, the center or unkeyed section 53A is partially keyed in the embodiment depicted in FIG. 10. Thus, a series of flats are provided, such as flat 66, cut along the apex 68 of the keyed sections 51A and 54A. A secondary flat 70 connects a flat section 72 of keyed section 51A with flat section 74 of keyed section 54A. The axial extent of the flat 66 is substantially that of the unkeyed center section 53 of the pin 38. Thus, the axial dimension 53A is substantially the same as the axial dimension of the unkeyed cylindrical section 53 for the pin 38.

By providing the structure of FIG. 10 for use in combination with the keyed openings, such as openings 34 and 36 of the handles 30 and 32, those keyed openings 34, 36 are more easily fitted into the fully keyed sections 51A and 54A. The flats or lands, such as lands 70, maintain the openings 34 and 36 properly axially aligned on the pin 38A. In other words, the openings 34, 36 are maintained in co-axial alignment with keyed sections 51A and 54A. This arrangement facilitates axial movement of the handles 30, 32. FIG. 13 is a cross sectional view illustrating this feature. The shaded sections of FIG. 13 comprise the portions thereof removed relative to the keyed sections.

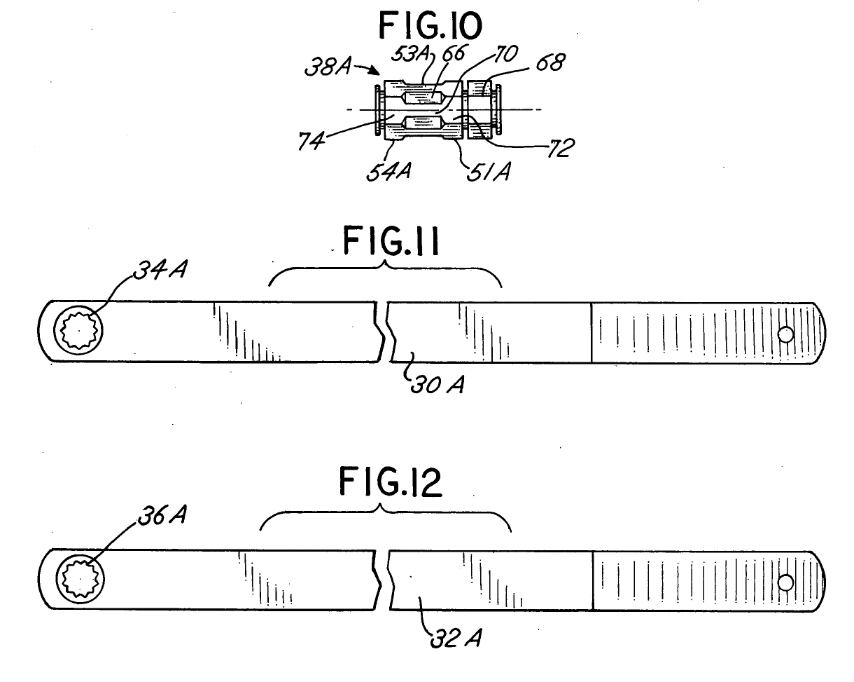

FIGS. 11 and 12 illustrate the alternative embodiment for the handles 30A and 32A. FIG. 11, for example, depicts the handle 30A which is functionally equivalent to the handle 30. FIG. 12 illustrates handle 32A which is functionally equivalent to the handle 32. The difference between the handles of FIGS. 11 and 12 with respect to the handles previously described is associated with the keyed openings 34A and 36A. First, the keyed openings 34A 36A comprise a regular duo decahedron. Also, the keyed openings 34A and 36A are slightly out of phase, one with respect to the other and the longitudinal axis of each handle 30A, 32A. Thus, as depicted in FIG. 12, the keyed opening 36A is approximately 7.5° out of phase with the keyed opening 34A of FIG. 11. As a result, shorter incremental movement may be effected utilizing the handles 30A and 32A as described.

Various other modifications may be made to the described tool. For example, the openings which are keyed in the handles 30 and 30A, 32 and 32A, may be sized and shaped to accommodate various rotational amounts of movement through interaction with the respective pins 38 and 38A.

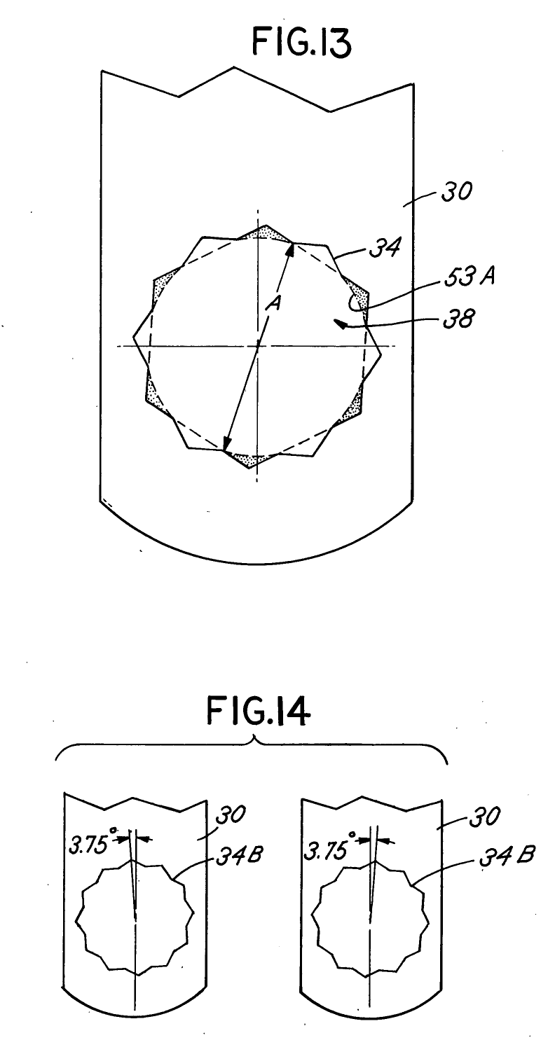

For example, as shown in FIG. 14, the handle 30 may include a keyed opening 34B offset by 3.75°. The same handle 30 may then be positioned on pin 38 by reversal thereof to effectively provide a 7.5° difference in the phase mounting on pin 38. In this manner, a single part may be manufactured to achieve the desired rotational phase difference. The outer end of the handle 30 in FIG. 14 may be bent or angled in opposite directions as shown in FIG. 2.

In the drawings, there is depicted a 12-sided keyed opening 34 and 36, 34A and 36A. However, different keying arrangements may be utilized. As previously mentioned, the keyed openings associated with the extension arm, extension bar 42 may also be altered to accommodate various needs. Thus, the tool as described may be used not only with a serpentine belt idler pulley, but other uses requiring incremental movement of such items in a restricted space may be effected utilizing the tool of the invention. Additionally, the keyed sections of the pin 38 may be offset relative to one another to accomplish the object of the out of phase relationship associated with the handles 32A and 30A described above. Further, the number of flats associated with the center section 53A may be varied. Such variance may, for example, may range from 2-12 or more sides. At least two of the flats associated with the center section 53A are coplanar with the facets or faces of the keyed sections 51A, 54A. Also, the pin 38 may be attached so that it projects through the arm 42 with a keyed section 51 or 54 on each side thereof and with a rotational section 53 on each side thereof. The invention is therefore to be limited only by the following claims and equivalents thereof.

What is claimed is:

1. A serpentine belt tool for releasing tension upon a serpentine belt tensioned by a biased idler pulley, said tool comprising, in combination:
a first actuation handle having a manual grip end and a drive end, said drive end including a keyed opening;
a second actuation handle having a manual grip end and a drive end, said drive end including a keyed opening;
an extension bar having a pivot pin projecting transversely from one end and including an idler pulley engaging element at the opposite end;
said pivot pin including a first key section compatible with the first actuator keyed opening, a second key section compatible with the second actuator keyed opening and a third unkeyed section, said first and second keyed openings of said first and second actuation handles respectively each being moveable into and out of engagement with the respective first and second key sections of the pivot pin, whereby the extension bar may be engaged with a pulley, and the pivot pin may be alternatively engaged and disengaged by one of said actuator handles to apply a force at the opposite end of the extension bar.

2. The tool of claim 1 wherein the handles and extension bar comprise flat bar stock.

3. The tool of claim 1 wherein the keyed openings are substantially polygonal.

4. The tool of claim 1 wherein the unkeyed section of the pin is intermediate the keyed sections.

5. The tool of claim 1 wherein the keyed sections of the pin are substantially polygonal.

6. The tool of claim 5 wherein the keyed sections of the pin are substantially hexagonal.

7. The tool of claim 1 wherein the unkeyed section of the pin is substantially circular.

8. The tool of claim 1 wherein the unkeyed section of the pin is substantially polygonal.

9. The tool of claim 8 wherein the unkeyed section of the pin is substantially hexagonal.

10. The tool of claim 8 wherein the keyed sections of the pin are substantially hexagonal and the unkeyed section is 12-sided having at least two sides thereof comprising extensions of the keyed sections.

11. The tool of claim 1 wherein the keyed openings of the handles are out of phase.

12. The tool of claim 1 wherein the keyed openings of the handle are in phase.

13. The tool of claim 1 wherein the handles are substantially identical.

14. The tool of claim 2 wherein at least one handle includes a grip end forming an angle with respect to the flat bar stock.
